(19) United States
(12) Patent Application Publication
(10) Pub. No.: US 2008/0274411 A1
(43) Pub. Date: Nov. 6, 2008

(54) Lithium Ion Secondary Battery

(76) Inventors: Junji Nakajima, Osaka (JP); Tsumoru Ohata, Kyoto (JP); Toshihiro Inoue, Aichi (JP)

Correspondence Address: MCDERMOTT WILL & EMERY LLP, 600 13TH STREET, N.W., WASHINGTON, DC, 20005-3096, US

(21) Appl. No.: 11/547,718

(22) PCT Filed: May 13, 2005
(86) PCT No.: PCT/JP05/08763

§ 371 Date: Oct. 6, 2006

(30) Foreign Application Priority Data
May 14, 2004 (JP) 2004-144503
Nov. 12, 2004 (JP) 2004-328747

(51) Int. Cl. H01M 6/18

(52) U.S. Cl. 429/322; 429/320

(57) ABSTRACT

A lithium ion secondary battery including: a positive electrode including a lithium composite oxide; a negative electrode capable of charging and discharging lithium ion; a non-aqueous liquid electrolyte; and a solid electrolyte layer interposed between the positive electrode and the negative electrode, wherein the solid electrolyte layer includes solid electrolyte particles and a binder. The solid electrolyte layer may include an inorganic oxide filler. The solid electrolyte particles is, for example, at least one selected from the group consisting of LiCl—Li₂O—P₂O₅, LiTi₂(PO₄)₃—AlPO₄, LiI—Li₂S—SiS₄, LiI—Li₂S—B₂S₃, LiI—Li₂S—P₂O₅ and Li₃N.

### TECHNICAL FIELD

The present invention relates to a highly safe lithium ion secondary battery that is excellent in charge/discharge characteristics, resistance to short circuit and heat resistance.

### BACKGROUND ART

Chemical batteries such as a lithium ion secondary battery include a separator between a positive electrode and a negative electrode that serves to provide electrical insulation between the respective electrode plates and also to retain an electrolyte. As the separator, a microporous thin film sheet comprising a resin such as polyethylene is mainly used at present. However, a thin film sheet comprising a resin generally tends to heat shrink by reaction heat resulting from short circuit that is instantaneously generated at the time of internal short circuit. For example, when a protruding object having a sharp shape, like a nail, penetrates the battery, a short-circuited portion may expand to further generate a large amount of reaction heat, thus accelerating a temperature rise in the battery.

In order to improve the battery safety, it has been proposed to form a porous protective film including inorganic solid particles such as alumina and a resin binder on the surface of the positive electrode or the negative electrode (e.g., see Patent Document 1). It has been also proposed to use glass ceramics having lithium ion conductivity for an electrolyte (e.g., see Patent Document 2).

Patent Document 1

Japanese Laid-Open Patent Publication No. Hei 7-220759

Patent Document 2

Japanese Laid-Open Patent Publication No. 2000-26135

### DISCLOSURE OF THE INVENTION

### Problem that the Invention is to Solve

Either an inorganic solid particle such as alumina or a resin binder does not have ion conductivity. Therefore, in the case of forming a protective film including inorganic solid particles such as alumina and a resin binder on the surface of the electrode, it is necessary to set the porosity of the protective film high, from the view point of maintaining the charge/discharge characteristics. When the porosity of the protective film is low, voids, into which the electrolyte is filled, decrease to inhibit ionic conduction. However, when the porosity of the protective film is set high, the strength of the porous film weakens to induce short circuit or the like, so that it is not possible to achieve the effect of improving the battery safety. That is, the charge/discharge characteristics and the safety are in a trade-off relationship, and it is difficult to achieve both of them at the same time.

In the case of using lithium ion conductive glass ceramics for the electrolyte, the battery safety improves satisfactory, because the glass ceramics are solid. However, since the ionic conductivity of the glass ceramics is insufficient as compared with that of an electrolyte including an organic non-aqueous solvent, it is difficult to ensure the charge/discharge characteristics.

Therefore, it is an object of the present invention to provide a lithium ion secondary battery that has excellent charge/discharge characteristics and is safer than in the past, by interposing a layer that is excellent in ionic conductivity and heat resistance between the positive electrode and the negative electrode.

### Means for Solving the Problem

The present invention relates to a lithium ion secondary battery including: a positive electrode including a lithium composite oxide; a negative electrode capable of charging and discharging lithium ion; a non-aqueous liquid electrolyte; and a solid electrolyte layer interposed between the positive electrode and the negative electrode, wherein the solid electrolyte layer includes solid electrolyte particles and a binder.

The solid electrolyte particles have ionic conductivity, while they are in a solid state. The migration of ions in the solid electrolyte is different from that of solvated ions moving in the liquid electrolyte. Since ions move inside the solid electrolyte, the ionic conductivity of the solid electrolyte is not affected by the presence or absence of the voids or the liquid electrolyte. Furthermore, the non-aqueous electrolyte is present between the positive electrode and the negative electrode, and the ion migration does not solely depend on the solid electrolyte, so that it is easy to ensure the charge/discharge characteristics.

It is preferable that the solid electrolyte particles include at least one selected from the group consisting of LiCl—Li₂O—P₂O₅ (a glassy composition including LiCl, Li₂O and P₂O₅), LiTi₂(PO₄)₃—AlPO₄ (a glassy composition including LiTi₂(PO₄)₃ and AlPO₄), LiI—Li₂S—SiS₄ (a glassy composition including LiI, Li₂S and SiS₄), LiI—Li₂S—B₂S₃ (a glassy composition including LiI, Li₂S and B₂S₃), LiI—Li₂S—P₂O₅ (a glassy composition including LiI, Li₂S and P₂O₅) and Li₃N. Additionally, it is preferable that the glassy composition is adjusted in its composition so as to have a lithium ion conductivity of 10⁻² to 10⁻⁴ S/cm.

The solid electrolyte layer may include an inorganic oxide filler.

Mixing the solid electrolyte particles and the inorganic oxide filler improves the liquid electrolyte retention capability of the solid electrolyte layer, also facilitates the impregnation of the electrode group with the liquid electrolyte, and, furthermore, can reduce the cost. It should be noted that the electrode group is obtained by winding or laminating the positive electrode and the negative electrode. If the impregnation of the electrode group with the liquid electrolyte is facilitated, then it is possible to reduce the tact time in manufacture. Additionally, there will be an improvement in terms of the performance deterioration due to depletion on the electrode surface, and therefore the life characteristics improve. Moreover, generation of a large Schottky barrier on the electrode surface is suppressed, so that the ion migration is facilitated and the charge/discharge characteristics are maintained.

Here, the solid electrolyte refers to an electrolyte that has “lithium ion conductivity” and is solid at normal temperature, and the inorganic oxide filler refers to inorganic oxide particles that do not have “lithium ion conductivity”.

The amount of the inorganic oxide filler included in the solid electrolyte layer is preferably not more than 100 parts by weight, and particularly preferably not less than 50 parts by weight and not more than 99 parts by weight, per 100 parts by weight of the solid electrolyte particles. When the amount of the inorganic oxide filler is too large, it may be difficult to improve the charge/discharge characteristics of the battery.

It is preferable that the solid electrolyte layer is bonded to at least one of the surface(s) of the positive electrode and the surface(s) of the negative electrode. By bonding the solid electrolyte layer to the electrode surface, it is possible to prevent the solid electrolyte layer from shrinking simultaneously when the separator (the microporous thin film sheet comprising a resin) heat shrinks.

It is preferable that the inorganic oxide filler includes at least one selected from the group consisting of titanium oxide, zirconium oxide, aluminum oxide and magnesium oxide. The reason is that they have excellent electrochemical stability.

It is preferable that the binder included in the solid electrolyte layer includes a rubber-like polymer including at least an acrylonitrile unit. The reason is that the rubber-like polymer including an acrylonitrile unit provides flexibility to the solid electrolyte layer, and thus facilitates formation of the electrode group.

It is preferable that the solid electrolyte particles have a scale-like shape. With the solid electrolyte particles having a scale-like shape, it is possible to prevent production of nonuniform voids (pores or through holes) in the solid electrolyte layer.

When the solid electrolyte particles have a scale-like shape with a major axis and a minor axis, it is preferable that the solid electrolyte particles have a major axis of not less than 0.1 μm and not more than 3 μm. It should be noted that the major axis means the maximum width of the particles. When the particles having a scale-like shape with a major axis of less than 0.1 μm are used, the filling rate of the solid electrolyte particles in the solid electrolyte layer becomes high, so that it may require a relatively long time to impregnate the electrode group with the liquid electrolyte, making it difficult to reduce the tact time in manufacture. When the major axis of the particles having a scale-like shape is greater than 3 μm, nonuniform voids may be easily produced when forming the solid electrolyte layer relatively thin, for example, in a thickness of not more than 6 μm.

It is preferable that the solid electrolyte layer has a thickness of not less than 3 μm and not more than 30 μm. When the thickness of the solid electrolyte layer is less than 3 μm, there is the possibility that leak current is produced, and, when it is thicker than 30 μm, the internal resistance increases, making it difficult to provide a high battery capacity.

In the lithium ion secondary battery of the present invention, a polyolefin layer may be further interposed between the positive electrode and the negative electrode. Here, the polyolefin layer includes polyolefin particles. As the polyolefin particles, it is preferable to use at least one selected from the group consisting of polyethylene particles and polypropylene particles. Preferably, the polyolefin layer includes a binder.

The internal temperature of the lithium ion secondary battery may increase to near 140° C. at the time of overcharge, although this depends on the composition of the electrode. When the internal temperature of the battery increases, polyolefin melts at a relatively low temperature and thus acts as a safety mechanism for interrupting current (that is, physically interrupting ion migration). Furthermore, polyolefin has tolerance to the environment inside the battery.

The polyolefin layer may be bonded to at least one of the surface(s) of the positive electrode and the surface(s) of the negative electrode.

The present invention includes, for example, the following.

(i) A lithium ion secondary battery in which the solid electrolyte layer is bonded to the surface of the negative electrode, and the polyolefin layer is bonded to the surface of the solid electrolyte layer.

(ii) A lithium ion secondary battery in which the polyolefin layer is bonded to the surface of the negative electrode, and the solid electrolyte layer is bonded to the surface of the polyolefin layer.

(iii) A lithium ion secondary battery in which the polyolefin layer is bonded to the surface of the negative electrode, and the solid electrolyte layer is bonded to the surface of the positive electrode.

(iv) A lithium ion secondary battery in which the solid electrolyte layer is bonded to the surface of the positive electrode, and the polyolefin layer is bonded to the surface of the solid electrolyte layer.

At the time of manufacturing the lithium ion secondary battery, the negative electrode can be obtained in a shorter tact time. Therefore, it is advantageous to form the solid electrolyte layer on the surface of the negative electrode, as the above-described (i), in terms of the manufacturing tact time. Further, the solid electrolyte layer is formed with a paste including the solid electrolyte particles and the binder. Accordingly, in the case of forming the solid electrolyte layer on the surface of the negative electrode first and then forming the polyolefin layer, it is possible to prevent the dispersion medium or the binder included in the paste from soaking into the voids between the polyolefin particles, making it possible to prevent a reduction in reproducibility.

From the viewpoint of effectively improving the life characteristics of the lithium ion secondary battery, it is advantageous to form the polyolefin layer on the surface of the negative electrode, as the above-described (ii). The reason is that forming the polyolefin layer on the surface of the negative electrode makes it possible to prevent the polyolefin from being oxidized by the positive electrode.

From the viewpoint of ensuring the manufacturing reproducibility of the lithium ion secondary battery and also effectively improving the life characteristics of the lithium ion secondary battery, it is advantageous to form the polyolefin layer on the surface of the negative electrode and form the solid electrolyte layer on the surface of the positive electrode, as the above-described (iii). The reason is that forming the solid electrolyte layer on the surface of the positive electrode makes it possible to prevent the dispersion medium or the binder included in the paste from soaking into the voids between the polyolefin particles in the polyolefin layer, while preventing the oxidation of polyolefin.

From the viewpoint of ensuring the manufacturing reproducibility of the lithium ion secondary battery and also effectively improving the life characteristics of the lithium ion secondary battery, and further reducing the manufacturing tact time, it is advantageous to form the solid electrolyte layer on the surface of the positive electrode and form the polyolefin layer on the surface of the solid electrolyte layer, as the above-described (iv).

### EFFECT OF THE INVENTION

With the present invention, it is possible to effectively obtain a highly safe lithium ion secondary battery that is excellent in charge/discharge characteristics, life characteristics, resistance to short circuit and heat resistance.

### BRIEF DESCRIPTION OF THE DRAWINGS

FIG. 1 is a vertical cross-sectional view of a cylindrical lithium ion secondary battery according to an example of the present invention.

### BEST MODE FOR CARRYING OUT THE INVENTION

A lithium secondary battery according to the present invention includes a positive electrode including a lithium composite oxide, a negative electrode capable of charging and discharging lithium ion, and a non-aqueous liquid electrolyte, wherein a solid electrolyte layer is interposed between the positive electrode and the negative electrode, and a polyolefin layer may be further interposed therebetween. It is preferable that the solid electrolyte layer includes solid electrolyte particles and a binder, and the polyolefin layer includes polyolefin particles, in particular, at least one selected from the group consisting of polyethylene particles and polypropylene particles. It is preferable that the polyolefin layer further includes a binder. The binder included in the solid electrolyte layer and the binder included in the polyolefin layer may be the same, or may be different. The lithium secondary battery according to the present invention may or may not further include a separator (a microporous thin film sheet) between the positive electrode and the negative electrode.

It is sufficient that the solid electrolyte layer is present between the positive electrode and the negative electrode. The present invention includes all such cases where the solid electrolyte layer is bonded to the surface of the positive electrode, where it is bonded to the surface of the negative electrode, and where it is bonded to the surface of the polyolefin layer. Similarly, the present invention includes all such cases where the polyolefin layer is bonded to the surface of the positive electrode, where it is bonded to the surface of the negative electrode, and where it is bonded to the surface of the solid electrolyte layer. However, from the viewpoint of preventing the oxidation of polyolefin, the polyolefin layer is preferably disposed such that the positive electrode and the polyolefin layer do not come into contact with each other.

For the solid electrolyte particles, it is possible to use, for example, glasses having ionic conductivity. Among them, it is preferable to use LiCl—Li₂O—P₂O₅, LiTi₂(PO₄)₃—AlPO₄, LiI—Li₂S—SiS₄, LiI—Li₂S—B₂S₃, LiI—Li₂S—P₂O₅, Li₃N and the like. These are effective to conduct ions, and most effective to conduct lithium ion. In general, materials other than these have poor lithium ion conductivity, and may cause energy loss. However, materials other than those described above can provide the effects of the present invention.

Although there is no particular limitation with respect to the shape of the solid electrolyte particles, it is preferably massive, spherical, fibrous or scale-like, for example, and it is particularly preferably scale-like. When the solid electrolyte particles have a scale-like shape, it is possible to obtain a uniform solid electrolyte layer in which the solid electrolyte particles are uniformly oriented in one direction. Furthermore, it seems that the particles will be spread like tiles, and, therefore, a through hole tends not to be formed in the solid electrolyte layer.

The major axis of the solid electrolyte particles having a scale-like shape is preferably not less than 0.1 μm and not more than 3 μm, on average. When the major axis is less than 0.1 μm, it requires a relatively long time to impregnate the electrode group with the liquid electrolyte, and, when the major axis exceeds 3 μm, non-uniform voids may be produced when forming the solid electrolyte layer into a relatively small thickness of not more than 6 μm, for example.

Although there is no particular limitation with respect to the binder included in the solid electrolyte layer or the polyolefin layer, it is possible to use, for example, polytetrafluoroethylene (PTFE), polyvinylidene fluoride (PVDF), styrene butadiene rubber (SBR), modified SBR including an acrylic acid unit or an acrylate unit, polyethylene, a polyacrylic acid-based derivative rubber (BM-500B (trade name) manufactured by ZEON Corporation) and modified acrylonitrile rubber (BM-720H (trade name) manufactured by ZEON Corporation). These may be used singly or in combination of two or more of them. Among them, modified acrylonitrile rubber is particularly preferable.

Modified acrylonitrile rubber is a rubber-like polymer including an acrylonitrile unit, and has the characteristics of being amorphous and having high heat resistance. A solid electrolyte layer containing such a binder tends not to cause cracking or the like when winding the positive electrode and the negative electrode with the solid electrolyte layer disposed therebetween, and therefore can maintain a high production yield of the lithium ion secondary battery.

In addition to an acrylonitrile unit, the rubber-like polymer including an acrylonitrile unit may include at least one selected from the group consisting of a methyl acrylate unit, an ethyl acrylate unit, a methyl methacrylate unit and an ethyl methacrylate unit. In addition, it may include: an alkyl acrylic acid ester such as n-propyl acrylate, isopropyl acrylate, t-butyl-acrylate, hexyl acrylate, cyclohexyl acrylate, dodecyl acrylate or lauryl acrylate; an alkyl methacrylic acid ester such as n-propyl methacrylate, isopropyl methacrylate, t-butyl-methacrylate, hexyl methacrylate, cyclohexyl methacrylate, dodecyl methacrylate or lauryl methacrylate; an unsaturated polycarboxylic acid alkyl ester such as dimethyl fumarate, diethyl maleate or butyl benzyl maleate; an unsaturated carboxylic acid ester including an alkoxy group, such as 2-methoxyethyl acrylate or 2-methoxyethyl methacrylate; or an α,β-unsaturated nitrile such as acrylonitrile or methacrylonitrile.

It is preferable to use a ceramic material for the inorganic oxide filler included in the solid electrolyte layer. The reason is that a ceramic material has high heat resistance, is electrochemically stable in the environment inside the battery, and also is suitable for the preparation of the paste. As the inorganic oxide, aluminum oxide such as α-alumina, titanium oxide, zirconium oxide, magnesium oxide or the like is most preferable in terms of electrochemical stability.

Although there is no particular limitation with respect to the average particle diameter of the inorganic oxide filler included in the solid electrolyte layer, it is preferably 0.1 to 6 μm, for example. Although there is no particular limitation with respect to the average particle diameter of the polyolefin particles included in the polyolefin layer, it is preferably 0.1 to 3 μm, for example. These average particle diameters can be measured, for example, with a wet-type laser particle size distribution measurement apparatus manufactured by Microtrac Inc. In this case, 50% value (median value: D₅₀) on a volume basis of the filler can be considered as the average particle diameter of the filler.

When the solid electrolyte layer does not include the inorganic oxide filler, the content of the solid electrolyte particles in the solid electrolyte layer is preferably not less than 50 wt % and not more than 99 wt %, and more preferably not less than 66 wt % and not more than 96 wt %. Accordingly, the content of the binder in the solid electrolyte layer is preferably not less than 1 wt % and not more than 50 wt %.

When the solid electrolyte layer includes the inorganic oxide filler, the total content of the solid electrolyte particles and the inorganic oxide filler in the solid electrolyte layer is preferably not less than 50 wt % and not more than 99 wt %, and more preferably not less than 66 wt % and not more than 96 wt %. However, the amount of the inorganic oxide filler is preferably not more than 100 parts by weight, per 100 parts by weight of the solid electrolyte particles.

The content of the polyolefin particles in the polyolefin layer is preferably not less than 50 wt % and not more than 99 wt %, and more preferably not less than 60 wt % and not more than 96 wt %. Accordingly, the content of the binder in the polyolefin layer is preferably not less than 1 wt % and not more than 50 wt %.

Additionally, when the content of the particles in each layer is less than 50 wt %, the particles cannot achieve the effect sufficiently, and it is difficult to control the micropore structure in each layer. On the other hand, when the content of the particles in each layer exceeds 99 wt %, there is a tendency that the strength of each layer is reduced. It should be noted that multiple layers of solid electrolyte layers or polyolefin layers having different compositions may be formed.

Preferably, a lithium composite oxide is used for the positive electrode, a material capable of charging and discharging lithium ion is used for the negative electrode, and a non-aqueous solvent in which lithium salt is dissolved is used as the non-aqueous liquid electrolyte.

As the lithium composite oxide, it is preferable to use, for example, lithium-containing transition metal oxides such as lithium cobaltate, lithium nickelate and lithium manganate. It is also preferable to use a modified product in which the transition metal in a lithium-containing transition metal oxide is partly replaced by another element. For example, the cobalt in lithium cobaltate is preferably replaced by aluminum, magnesium or the like, and the nickel in lithium nickelate is preferably replaced by cobalt. The lithium composite oxides may be used singly or in combination of two or more of them.

Examples of the material capable of charging and discharging lithium ion used for the negative electrode include various natural graphites, various artificial graphites, silicon-based composite materials and various alloy materials. These materials may be used singly or in combination of two or more of them.

In general, the positive electrode and the negative electrode include an electrode binder. For the electrode binder, it is possible to use, for example, polytetrafluoroethylene (PTFE), polyvinylidene fluoride (PVDF), styrene butadiene rubber (SBR), a polyacrylic acid-based derivative rubber (BM-500B (trade name) manufactured by ZEON Corporation) and modified acrylonitrile rubber (BM-720H (trade name) manufactured by ZEON Corporation). These may be used singly or in combination of two or more of them.

The electrode binder can be used in combination with a thickener. As the thickener, it is possible to use, for example, carboxymethyl cellulose (CMC), polyethylene oxide (PEO) and modified acrylonitrile rubber (BM-720H manufactured by ZEON Corporation). These may be used singly or in combination of two or more of them.

In general, the positive electrode includes a conductive agent. As the conductive agent, it is possible to use carbon black (e.g., acetylene black and Ketjen Black) and various graphites, for example. These may be used singly or in combination of two or more of them.

Although there is no particular limitation with respect to the non-aqueous solvent, for example, it is possible to use: carbonic acid esters such as ethylene carbonate (EC), propylene carbonate (PC), dimethyl carbonate (DMC), diethyl carbonate (DEC) and ethylmethyl carbonate (EMC); carboxylic acid esters such as γ-butyrolactone, γ-valerolactone, methyl formate, methyl acetate and methyl propionate; and ethers such as dimethyl ether, diethyl ether and tetrahydrofuran. The non-aqueous solvents may be used singly or in combination of two or more of them. Among them, it is particularly preferable to use carbonic acid esters.

Although there is no particular limitation with respect to the lithium salt, it is preferable to use LiPF₆, LiBF₄ and the like, for example. These may be used singly or in combination.

In order to ensure the stability at the time of overcharge, it is preferable to add, to the non-aqueous electrolyte, a small amount of an additive such as vinylene carbonate (VC), vinyl ethylene carbonate (VEC), or cyclohexylbenzene (CHB) for forming a good film on the positive electrode and/or the negative electrode.

When the lithium ion secondary battery of the present invention includes the microporous thin film sheet as the separator, it is preferable that the microporous thin film sheet includes a polyolefin resin. A polyolefin resin has resistance to the environment inside the battery, and can provide a shutdown function to the separator. The shutdown function is a function of the separator to melt and close its micropores, when the battery temperature becomes extremely high due to some failure. This stops the ion passage through the liquid electrolyte, thus maintaining the safety of the battery. For example, a single layer film including a polyethylene resin or a polypropylene resin, and a multilayer film including two or more polyolefin resins are suitable as the microporous thin film sheet. Although there is no particular limitation with respect to the thickness of the separator, it is 5 to 20 μm, for example. Use of the separator makes it even more difficult to cause short circuit, thus improving the safety and the reliability of the lithium ion secondary battery.

Although there is no particular limitation with respect to the thickness of the solid electrolyte layer, it is preferably not less than 3 μm and not more than 30 μm, from the viewpoint of ensuring, for example, the effect of improving the safety, and also ensuring the design capacity of the battery. Although there is also no particular limitation with respect to the thickness of the polyolefin layer, it is preferably not less than 3 μm and not more than 30 μm, from the viewpoint of ensuring, for example, the effect of improving the safety, and also ensuring the design capacity of the battery. The specific thicknesses of these layers are determined, for example, when the separator is also used, in consideration of the liquid electrolyte retention capability of the separator, and also in consideration of the speed of impregnation of the electrode group with the liquid electrolyte and the like in the manufacturing process.

When the lithium ion secondary battery does not include the microporous thin film sheet as the separator, the thickness of the solid electrolyte layer or the polyolefin layer is preferably not less than 10 μm and not more than 30 μm. When the lithium ion secondary battery includes the microporous thin film sheet as the separator, the thickness of the solid electrolyte layer or the polyolefin layer is preferably not less than 3 μm and not more than 15 μm. Additionally, from the viewpoint of maintaining the design capacity of the battery, the total thickness of the solid electrolyte layer, the polyolefin layer and the separator is preferably set to 15 to 30 μm.

Although there is no particular limitation with respect to the method for forming the solid electrolyte layer or the polyolefin layer, for example, a paste including the solid electrolyte particles and a binder or a paste including the polyolefin particles and a binder is applied onto an active material layer of a primary electrode sheet including a current collector and an active material layer carried on the current collector, followed by drying. Although the application of the paste is preferably performed by a comma roll method, a gravure roll method, a die coating method or the like, it is not limited to these. It should be noted that the primary electrode sheet means a precursor of the electrode plate before cutting into a predetermined shape according to the battery size.

The paste including the solid electrolyte particles and a binder is obtained by mixing the solid electrolyte particles and a binder, together with a liquid component (dispersion medium). Although it is possible to use, for example, water, NMP or cyclohexanone as the liquid component, it is not limited to these. The mixing of the solid electrolyte particles, the binder, and the dispersion medium can be carried out using a double arm kneader such as a planetary mixer or a wet dispersing machine such as a beads mill. The paste including the polyolefin particles and a binder can also be obtained in the same manner.

Hereinafter, the present invention is described by way of examples; however, these examples are intended to illustrate the lithium ion secondary battery according to the present invention, and are not intended to limit the present invention.

### COMPARATIVE EXAMPLE 1

### (i) Production of Positive Electrode

A positive electrode material mixture paste was prepared by stirring 3 kg of lithium cobaltate (LiCoO₂: a positive electrode active material), 120 g of PVDF (a positive electrode binder: a solid content of PVDF #1320 (trade name) manufactured by KUREHA CORPORATION) and 90 g of acetylene black (a positive electrode conductive agent) with a double arm kneader, together with a proper amount of N-methyl-2-pyrrolidone (NMP). This paste was applied onto both sides of an aluminum foil having a thickness of 15 μm, followed by drying to obtain a primary positive electrode sheet. This primary positive electrode sheet was rolled to have a total thickness of 160 μm, and then cut to have a width that could be inserted into a 18650 type cylindrical battery can, thus obtaining a positive electrode hoop.

### (ii) Production of Negative Electrode

A negative electrode material mixture paste was prepared by stirring 3 kg of artificial graphite (a negative electrode active material), 30 g of styrene-butadiene rubber (a negative electrode binder: a solid content of BM-400B (trade name) manufactured by ZEON Corporation) and 30 g of carboxymethyl cellulose (CMC: a thickener) with a double arm kneader, together with a proper amount of water. This paste was applied onto both sides of a copper foil having a thickness of 10 μm, followed by drying to obtain a primary negative electrode sheet. This primary negative electrode sheet was rolled to have a total thickness of 180 μm, and then cut to have a width that could be inserted into a 18650 type cylindrical battery can, thus obtaining a negative electrode hoop.

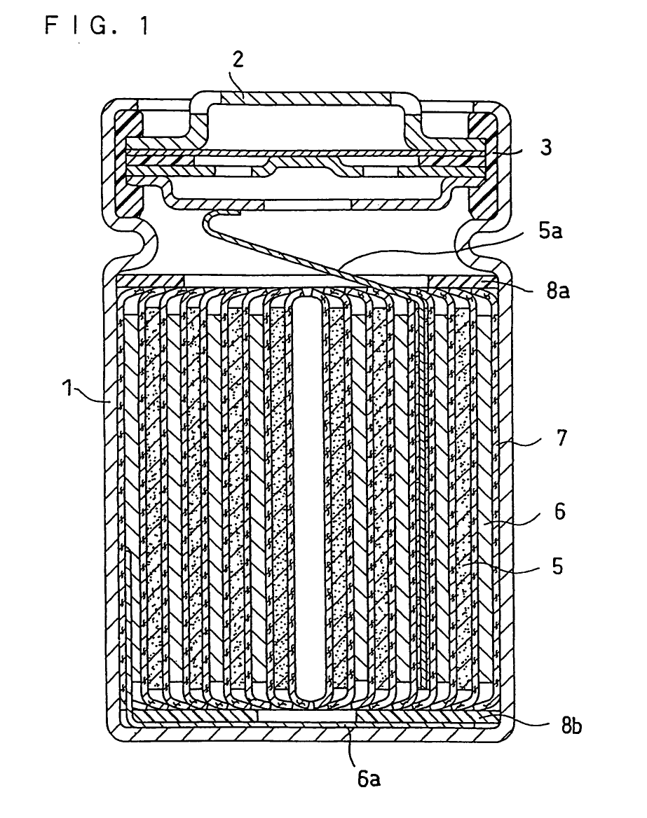

A cylindrical battery with a product number 18650, as shown in FIG. 1, was fabricated using the above-described positive electrode hoop and negative electrode hoop.

Each of the positive electrode hoop and the negative electrode hoop was cut into a predetermined length to obtain a positive electrode 5 and a negative electrode 6. One end of a positive electrode lead 5a was connected to the positive electrode 5, and one end of a negative electrode lead 6a was connected to the negative electrode 6. The positive electrode 5 and the negative electrode 6 were wound, with a microporous thin film sheet (a separator 7) made of a polyethylene resin and having a thickness of 20 μm disposed therebetween, thereby constructing an electrode group. Being sandwiched between an upper insulating ring 8a and a lower insulating ring 8b, this electrode group was inserted into a cylindrical 18650 battery can 1, into which 5.5 g of a non-aqueous liquid electrolyte was then injected.

The non-aqueous liquid electrolyte was obtained by dissolving LiPF₆ at a concentration of 1 mol/L in a mixed solvent containing ethylene carbonate, dimethyl carbonate and ethylmethyl carbonate at a volume ratio of 2:3:3, and further dissolving therein 3 wt % of vinylene carbonate.

The other end of the positive electrode lead 5a was welded to the rear surface of a battery lid 2, and the other end of the negative electrode lead 6a was welded to the inner bottom surface of the battery can 1. Finally, the opening of the battery can 1 was sealed with the battery lid 2, which included an insulating packing 3 disposed at its periphery. Thus, a cylindrical lithium ion secondary battery was completed.

### EXAMPLE 1

A cylindrical lithium ion secondary battery was fabricated in the same manner as in Comparative Example 1, except that a solid electrolyte layer was formed on both sides of the negative electrode hoop, and that a glassy composition (YC-LC powder (trade name) manufactured by OHARA INC., having a major axis of 1 μm and the composition: LiCl—Li₂O—P₂O₅) was used for the solid electrolyte particles having a scale-like shape and ionic conductivity.

Specifically, a paste was prepared by stirring 970 g of the solid electrolyte particles, 30 g of modified acrylonitrile rubber (a solid content of BM-720H (trade name) manufactured by ZEON Corporation) and a proper amount of NMP with a double arm kneader. The same operations as those of Comparative Example 1 were carried out, except that this paste was applied onto both sides of the negative electrode hoop, followed by drying to form a solid electrolyte layer having a thickness of 5 μm per side.

### EXAMPLE 2

A solid electrolyte layer was formed on both sides of the negative electrode hoop in the same manner as in Example 1, except that the thickness of the solid electrolyte layer was changed to 20 μm per side. Further, a cylindrical lithium ion secondary battery was fabricated in the same manner as in Comparative Example 1, except that this negative electrode hoop was used, and also that the separator was not used.

### EXAMPLE 3

A cylindrical lithium ion secondary battery was fabricated in the same manner as in Comparative Example 1, except that a solid electrolyte layer was formed on both sides of the negative electrode hoop using a glassy composition manufactured by OHARA INC. (YC-LC powder (trade name), having a major axis of 1 μm and the composition: LiCl—Li₂O—P₂O₅) for the solid electrolyte particles having a scale-like shape and ionic conductivity, and using α-alumina having an average particle diameter of 0.3 μm for the inorganic oxide filler.

Specifically, a paste was prepared by stirring 490 g of the solid electrolyte particles, 480 g of the inorganic oxide filler, 30 g of modified acrylonitrile rubber (a solid content of BM-720H (trade name) manufactured by ZEON Corporation) and a proper amount of NMP with a double arm kneader. The same operations as those of Comparative Example 1 were carried out, except that this paste was applied onto both sides of the negative electrode hoop, followed by drying to form a solid electrolyte layer having a thickness of 5 μm per side.

### EXAMPLES 4 TO 8

Solid electrolyte layers were formed on both sides of the negative electrode hoops in the same manner as in Example 3, except that the thickness of the solid electrolyte layer per side was changed to 5 μm (Example 4), 10 μm (Example 5), 15 μm (Example 6), 25 μm (Example 7) and 30 μm (Example 8). Cylindrical lithium ion secondary batteries were fabricated in the same manner as in Comparative Example 1, except that these negative electrode hoops were used, and also that the separator was not used.

### EXAMPLE 9

A cylindrical lithium ion secondary battery was fabricated in the same manner as in Example 4, except that titania having an average particle diameter of 0.3 μm was used in place of α-alumina as the inorganic oxide filler.

### EXAMPLE 10

A cylindrical lithium ion secondary battery was fabricated in the same manner as in Example 4, except that zirconia having an average particle diameter of 0.3 μm was used in place of α-alumina as the inorganic oxide filler.

### EXAMPLE 11

A cylindrical lithium ion secondary battery was fabricated in the same manner as in Example 4, except that magnesia having an average particle diameter 0.3 μm was used in place of α-alumina as the inorganic oxide filler.

It should be noted that, when the major axis of the solid electrolyte particles was set to less than 0.1 μm in Examples 1 to 11, uniform application of the paste including the solid electrolyte particles and the binder was relatively difficult, and the product yield was reduced. Furthermore, for the batteries obtained using the solid electrolyte particles having a major axis of less than 0.1 μm, it required a relatively long time to impregnate the electrode group with the non-aqueous liquid electrolyte. On the other hand, when the major axis of the solid electrolyte particles was changed to 4 μm, there were cases where large voids, which could induce formation of dendrites in the solid electrolyte layer, were produced.

When the thickness of the solid electrolyte layer was changed to less than 3 μm in Examples 1 to 11, generation of leak current was confirmed in some of the batteries. Accordingly, it was found that the thickness of the solid electrolyte layer is preferably set to not less than 3 μm. Further, when the thickness of the solid electrolyte layer was larger than 30 μm, the flexibility of the solid electrolyte layer was reduced, and a reduction in the production yield and an increase in the internal resistance of the batteries were observed. Accordingly, it was found that the thickness of the solid electrolyte layer is preferably set to not more than 30 μm.

### EXAMPLE 12

A cylindrical lithium ion secondary battery was fabricated in the same manner as in Example 4, except that a polyolefin layer was formed on the surface of the 5 μm-thick solid electrolyte layer.

Specifically, a paste was prepared by stirring 980 g of high-density polyethylene particles (having an melting point of 133% and an average particle diameter of 1 μm), which were polyolefin particles, 20 g of modified acrylonitrile rubber (a solid content of BM-720H (trade name) manufactured by ZEON Corporation) and a proper amount of NMP with a double arm kneader. The same operations as those of Example 4 were carried out, except that this paste was applied onto the surface of the solid electrolyte layer, followed by drying to form a polyolefin layer having a thickness of 5 μm per side.

### EXAMPLE 13

A cylindrical lithium ion secondary battery was fabricated in the same manner as in Example 12, except that the arrangement of the solid electrolyte layer and the polyolefin layer was reversed.

Specifically, the same operations as those of Comparative Example 1 were carried out, except that the paste including the polyolefin particles and the binder was first applied onto both sides of the negative electrode hoop, followed by drying to form a polyolefin layer having a thickness of 5 μm per side, and then the paste including the solid electrolyte particles, the inorganic oxide filler and the binder was applied to the surface of the polyolefin layer (PO layer), followed by drying to form a solid electrolyte layer having a thickness of 5 μm per side.

### EXAMPLE 14

The paste prepared in Example 12, which included the polyolefin particles and the binder, was applied onto both sides of the negative electrode hoop, followed by drying to form a polyolefin layer having a thickness of 5 μm per side. On the other hand, the paste prepared in Example 3, which included the solid electrolyte particles, the inorganic oxide filler and the binder, was applied onto both sides of the positive electrode hoop, followed by drying to form a solid electrolyte layer having a thickness of 5 μm per side. A cylindrical lithium ion secondary battery was fabricated in the same manner as in Comparative Example 1, except that the thus obtained positive electrode hoop and negative electrode hoop were used, and that the separator was not used.

### EXAMPLE 15

The paste prepared in Example 3, which included the solid electrolyte particles, the inorganic oxide filler and the binder, was applied onto both sides of the positive electrode hoop, followed by drying to form a solid electrolyte layer having a thickness of 5 μm per side. Then, the paste prepared in Example 12, which included the polyolefin particles and the binder, was applied onto the surface of the solid electrolyte layer, followed by drying to form a polyolefin layer having a thickness of 5 μm per side. A cylindrical lithium ion secondary battery was fabricated in the same manner as in Comparative Example 1, except that the thus obtained positive electrode hoop was used, and that the separator was not used.

### EXAMPLE 16

The paste prepared in Example 3, which included the solid electrolyte particles, the inorganic oxide filler and the binder, was applied onto a polytetrafluoroethylene (PTFE) sheet, followed by drying, and, when this was separated from the PTFE sheet, a solid electrolyte sheet having a thickness of 25 μm was obtained. A cylindrical lithium ion secondary battery was fabricated in the same manner as in Comparative Example 1, except that this solid electrolyte sheet was interposed between the positive electrode and the negative electrode, and that the separator was not used.

### EXAMPLE 17

The paste prepared in Example 3, which included the solid electrolyte particles, the inorganic oxide filler and the binder, was applied onto a polytetrafluoroethylene (PTFE) sheet, followed by drying to form a solid electrolyte layer having a thickness of 5 μm on the PTFE sheet. Then, the paste prepared in Example 12, which included the polyolefin particles and the binder, was applied onto the surface of the solid electrolyte layer, followed by drying to form a polyolefin layer having a thickness of 5 μm. When these two layers were separated from the PTFE sheet, a solid electrolyte sheet having a thickness of 10 μm was obtained. A cylindrical lithium ion secondary battery was fabricated in the same manner as in Comparative Example 1, except that this solid electrolyte sheet was interposed between the positive electrode and the negative electrode, and that the separator was not used.

### EXAMPLE 18

A cylindrical lithium ion secondary battery was fabricated in the same manner as in Example 2, except that a mixture of equal weights of a polystyrene (PS) resin and polyethylene oxide (PEO) was used in place of the modified acrylonitrile rubber as the binder included in the solid electrolyte layer.

### Evaluation

The batteries of the examples and the comparative examples were evaluated by the following method.

### —Condition of Solid Electrolyte Layer—

The condition of each of the solid electrolyte layers immediately after formation was observed by visual inspection to check whether any chipping, cracking or separation occurred in the solid electrolyte layer. In all the examples, the condition of the solid electrolyte layer was favorable.

### —Electrode Appearance—

The condition of the positive electrode or the negative electrode immediately after formation of the solid electrolyte layer was observed by visual inspection to check whether any problem such as a size change occurred. In all the examples, the electrode appearance was favorable.

### —Flexibility of Solid Electrolyte Layer—

The positive electrode and the negative electrode were wound around a core, with the solid electrolyte layer interposed therebetween, thus forming 10 half-finished electrode groups for each of the examples. Then, the winding was unwound, and the condition of a portion of the solid electrolyte layer that was near the core was mainly observed by visual inspection to check whether any chipping, cracking or separation occurred in the solid electrolyte layer. Although there was a failure in only one of the batteries of Example 8, no failure was observed in the rest of the examples.

### —Design Capacity of Battery—

Although the inner diameter of the battery can was 18 mm, the diameter of the electrode group was set to 16.5 mm, giving priority to insertion. The design capacity of each battery was obtained from the weight of the positive electrode in that design, taking the capacity per gram of the positive electrode active material as 142 mAh. The results are shown in Table 1.

### —Charge/Discharge Characteristics—

Each of the non-defective, completed batteries was subjected to preliminary charge/discharge twice, and stored for seven days under an environment with 45° C. Thereafter, charging and discharging were performed under an environment with 20° C. as follows:

(1) Constant current discharge: 400 mA (end voltage 3 V)
(2) Constant current charge: 1400 mA (end voltage 4.2 V)
(3) Constant voltage charge: 4.2 V (end current 100 mA)
(4) Constant current discharge: 400 mA or 4000 mA (end voltage 3 V)

The charge/discharge capacities at this time are shown in Table 1.

### —Safety Against Nail Penetration—

Each of the batteries after the evaluation of the charge/discharge characteristics was subjected to charging in an environment with 20° C. as follows:

(1) Constant current charge: 1400 mA (end voltage 4.25 V)
(2) Constant voltage charge: 4.25 V (end current 100 mA)

An iron round nail having a diameter of 2.7 mm was penetrated into each of the charged batteries from its side at a speed of 5 mm/sec or 180 mm/sec under an environment with 20° C., and the heat generation state of the battery at that time was observed. The temperatures of the battery at one second and 90 seconds after the nail penetration were shown in Table 1.

It should be noted that, when the positive electrode and the negative electrode come into contact (short-circuited) as a result of the nail penetration, Joule heat is generated. The separator, which has low heat resistance, is melted by the Joule heat, and forms a robust short circuit portion. Consequently, the generation of Joule heat continues, and the temperature increases to a region in which the positive electrode becomes thermally instable. When the nail penetration speed is decreased, localized heat generation is accelerated. The reason is that the short-circuited area produced per unit time is limited, and a considerable amount of heat is concentrated at the limited location. On the other hand, when the nail penetration speed is increased to expand the short-circuited area produced per unit time, heat is dispersed in a large area, so that the temperature increase of the battery is alleviated.

TABLE 1

| | Solid electrolyte layer | | | | | |
|---|---|---|---|---|---|---|
| | | | Inorganic | | Separator | PO layer |
| | Bonded | Thickness | oxide | | Thickness | Bonded |
| Example | location | (μm) | filler | Binder | (μm) | location |
| 1 | negative | 5 | — | modified | 20 | — |
| | electrode | | | AN | | |
| 2 | negative | 20 | — | modified | — | — |
| | electrode | | | AN | | |
| 3 | negative | 5 | alumina | modified | 20 | — |
| | electrode | | | AN | | |
| 4 | negative | 5 | alumina | modified | — | — |
| | electrode | | | AN | | |
| 5 | negative | 10 | alumina | modified | — | — |
| | electrode | | | AN | | |
| 6 | negative | 15 | alumina | modified | — | — |
| | electrode | | | AN | | |
| 7 | negative | 25 | alumina | modified | — | — |
| | electrode | | | AN | | |
| 8 | negative | 30 | alumina | modified | — | — |
| | electrode | | | AN | | |
| 9 | negative | 5 | titania | modified | — | — |
| | electrode | | | AN | | |
| 10 | negative | 5 | zirconia | modified | — | — |
| | electrode | | | AN | | |
| 11 | negative | 5 | magnesia | modified | — | — |
| | electrode | | | AN | | |
| 12 | negative | 5 | alumina | modified | — | SE layer |
| | electrode | | | AN | | |
| 13 | PO layer | 5 | alumina | modified | — | negative |
| | | | | AN | | electrode |
| 14 | positive | 5 | alumina | modified | — | negative |
| | electrode | | | AN | | electrode |
| 15 | positive | 5 | alumina | modified | — | SE layer |
| | electrode | | | AN | | |
| 16 | — | 25 | alumina | modified | — | — |
| | | | | AN | | |
| 17 | — | 5 | alumina | modified | — | SE layer |
| | | | | AN | | |
| 18 | negative | 20 | — | PS + PEO | — | — |
| | electrode | | | | | |
| Com. | — | — | — | — | 20 | — |
| Ex. 1 | | | | | | |

| | | | | | Safety against nail | | | |
|---|---|---|---|---|---|---|---|---|
| | | | | | penetration (reached | | | |
| | | | | | temperature) | | | |
| | | Charge/discharge | | | Nail speed | | Nail speed | |
| | | characteristics | | | 5 mm/sec | | 180 mm/sec | |
| | | | Discharge | | | after | | after |
| | Design | | 400 | 4000 | after | 90 | after | 90 |
| | capacity | Charge | mAh | mAh | 1 sec | sec | 1 sec | sec |
| Example | (mAh) | (mAh) | (mAh) | (mAh) | (° C.) | (° C.) | (° C.) | (° C.) |
| 1 | 1943 | 1939 | 1936 | 1893 | 67 | 81 | 64 | 82 |
| 2 | 2014 | 2016 | 2014 | 1922 | 67 | 83 | 68 | 83 |
| 3 | 1943 | 1942 | 1941 | 1902 | 68 | 88 | 72 | 89 |
| 4 | 2249 | 2244 | 2235 | 2027 | 72 | 94 | 69 | 96 |
| 5 | 2171 | 2171 | 2169 | 2053 | 69 | 89 | 70 | 88 |
| 6 | 2094 | 2096 | 2094 | 1978 | 69 | 87 | 68 | 84 |
| 7 | 1943 | 1944 | 1943 | 1898 | 68 | 83 | 66 | 83 |
| 8 | 1873 | 1874 | 1872 | 1787 | 65 | 79 | 62 | 79 |
| 9 | 2247 | 2247 | 2246 | 2193 | 67 | 88 | 70 | 88 |
| 10 | 2249 | 2250 | 2248 | 2198 | 66 | 86 | 68 | 85 |
| 11 | 2250 | 2250 | 2243 | 2201 | 66 | 89 | 65 | 85 |
| 12 | 2171 | 2172 | 2170 | 2068 | 64 | 77 | 63 | 76 |
| 13 | 2171 | 2171 | 2170 | 2067 | 63 | 76 | 62 | 75 |
| 14 | 2171 | 2172 | 2171 | 2070 | 61 | 74 | 63 | 73 |
| 15 | 2171 | 2171 | 2170 | 2068 | 62 | 76 | 60 | 74 |
| 16 | 1943 | 1945 | 1943 | 1904 | 64 | 82 | 66 | 81 |
| 17 | 2171 | 2168 | 2168 | 2054 | 63 | 81 | 65 | 83 |
| 18 | 2014 | 2012 | 2002 | 1886 | 83 | 102 | 82 | 99 |
| Com. | 2015 | 2014 | 2003 | 1888 | 146 | — | 138 | — |
| Ex. 1 | | | | | | | | |

PO layer: polyolefin layer, modified AN: modified acrylonitrile rubber, PS: polystyrene, PEO: polyethylene oxide, SE layer: solid electrolyte layer

In the following, the evaluation results are described.

### (i) Regarding the Presence or Absence of Solid Electrolyte Layer

In Comparative Example 1, in which the solid electrolyte layer was not present, overheating after an elapse of one second after the nail penetration was prominent, regardless of the nail penetration speed. In contrast, in the examples in which the solid electrolyte layer was bonded to the surface of the electrode, overheating after the nail penetration was significantly suppressed. As a result of disassembling and examining each of the batteries after the nail penetration test, a wide area of the separator was melted in the battery of Comparative Example 1. On the other hand, in each of the examples, the solid electrolyte layer retained its original shape. This shows that, when the solid electrolyte layer has sufficient heat resistance, the solid electrolyte layer will not be destroyed even if the battery generates heat owing to the internal short-circuit caused by the nail penetration. Therefore, it seems that, with the solid electrolyte layer, it is possible to suppress expansion of the short circuit area, and prevent significant overheating.

### (ii) Regarding Thickness of Solid Electrolyte Layer

Although it seems that the resistance increases with an increase in the thickness of the solid electrolyte layer, the dependency of the battery characteristics on the thickness of the solid electrolyte layer was relatively low, as shown in Examples 4 to 8. This indicates that the influence of the solid electrolyte layer on the internal resistance is small. However, when the amount of the binder included in the solid electrolyte layer was extremely large, there was a tendency that the internal resistance increased and the battery performance reduced. Conversely, when the amount of the binder included in the solid electrolyte layer was extremely small, there were cases where the strength of the solid electrolyte layer decreased and the solid electrolyte layer was damaged at the time of constructing the electrode group.

(iii) Regarding the Type of Binder

In each of the examples in which a proper amount of modified acrylonitrile rubber (a rubber-like polymer including an acrylonitrile unit) was used as the binder, it was easy to construct the electrode group, and the battery characteristics were favorable. It should be noted that polystyrene (PS) and polyethylene oxide (PEO), which were used in Example 18, seemed to have experienced oxidation at a voltage of 4 V or higher, although they have excellent flexibility.

### (iv) Regarding the Type of Inorganic Oxide Filler

Use of the inorganic oxide filler facilitated the impregnation of the electrode group with the liquid electrolyte, thus making it possible to reduce the tact time in the manufacturing process of the battery. Such an effect was substantially similarly obtained in cases where any of alumina, titania, zirconia and magnesia was used. For example, when the time required for the impregnation of the electrode group with the liquid electrolyte was compared between Example 7 and Example 2, Example 7 required about one fourth the time required by Example 2.

### (v) Regarding Bonded Location of Solid Electrolyte Layer

When the bonded location of the solid electrolyte layer was changed, similar charge/discharge characteristics and safety against nail penetration were also achieved. However, when the solid electrolyte layer was formed on the surface of the negative electrode to bring the polyolefin layer into contact with the positive electrode, there was a tendency that the life characteristics of the battery were slightly reduced. Further, as indicated by Examples 16 to 17, favorable safety against nail penetration was also achieved when the solid electrolyte layer was not bonded to the surface of the electrode. The reason seems to be that the main component of the solid electrolyte layer is a solid electrolyte or an inorganic filler, and therefore does not heat-shrink in most cases. However, from the viewpoint of the production tact time or yield, it is preferable to bond the solid electrolyte layer to the surface of the electrode.

### (vi) Regarding Polyolefin Layer

A particularly favorable result was obtained in the nail penetration test for each of the batteries that included the polyolefin layer. The reason seems to be that the effects of heat absorption by the polyethylene and current blocking (shutdown function) by the melted polyethylene were exerted. The safety was also improved when polypropylene was used in place of the polyethylene.

Batteries similar to those described above were produced by varying the composition for the electrode material, the solid electrolyte layer, the polyolefin layer and the like within a scope of the present invention, and, as a result of evaluation, each of the batteries was excellent in terms of charge/discharge characteristics and safety.

Additionally, cylindrical lithium ion secondary batteries were fabricated in the same manner as in Examples 1, 4, 12 and so on, except that LiTi₂(PO₄)₃—AlPO₄, LiI—Li₂S—SiS₄, LiI—Li₂S—B₂S₃, LiI—Li₂S—P₂O₅ and Li₃N were respectively used in place of LiCl—Li₂O—P₂O₅ for the solid electrolyte particles, and, as a result of the same evaluation as described above, each achieved the same effects as those of Examples 1, 4, 12 and so on.

### INDUSTRIAL APPLICABILITY

The present invention is particularly useful for provision of a high-performance lithium secondary battery that is required to be excellent both in terms of safety and charge/discharge characteristics. The lithium secondary battery of the present invention is highly safe, and therefore is particularly useful as a power source for portable equipment.

1. A lithium ion secondary battery comprising:
a positive electrode including a lithium composite oxide; a negative electrode capable of charging and discharging lithium ion; a non-aqueous liquid electrolyte; and a solid electrolyte layer interposed between said positive electrode and said negative electrode,
wherein said solid electrolyte layer includes solid electrolyte particles and a binder.

2. The lithium ion secondary battery in accordance with claim 1,
wherein said solid electrolyte layer includes an inorganic oxide filler.

3. The lithium ion secondary battery in accordance with claim 1,
wherein said solid electrolyte layer is bonded to at least one of a surface of said positive electrode and a surface of said negative electrode.

4. The lithium ion secondary battery in accordance with claim 1,
wherein said solid electrolyte particles include at lease one selected from the group consisting of LiCl—Li₂O—P₂O₅, LiTi₂(PO₄)₃—AlPO₄, LiI—Li₂S—SiS₄, LiI—Li₂S—B₂S₃, LiI—Li₂S—P₂O₅ and Li₃N.

5. The lithium ion secondary battery in accordance with claim 2,
wherein said inorganic oxide filler includes at least one selected from the group consisting of titanium oxide, zirconium oxide, aluminum oxide and magnesium oxide.

6. The lithium ion secondary battery in accordance with claim 1,
wherein said binder includes a rubber-like polymer including at least an acrylonitrile unit.

7. The lithium ion secondary battery in accordance with claim 1,
wherein said solid electrolyte particles have a scale-like shape.

8. The lithium ion secondary battery in accordance with claim 7,
wherein said solid electrolyte particles have a major axis of not less than 0.1 μm and not more than 3 μm.

9. The lithium ion secondary battery in accordance with claim 1,
wherein said solid electrolyte layer has a thickness of not less than 3 μm and not more than 30 μm.

10. The lithium ion secondary battery in accordance with claim 1,
wherein a polyolefin layer is further interposed between said positive electrode and said negative electrode, and said polyolefin layer includes polyolefin particles.

11. The lithium ion secondary battery in accordance with claim 10,
wherein said polyolefin layer is bonded to at least one of a surface of said positive electrode and a surface of said negative electrode.

12. The lithium ion secondary battery in accordance with claim 10,
wherein said solid electrolyte layer is bonded to a surface of said negative electrode, and said polyolefin layer is bonded to a surface of said solid electrolyte layer.

13. The lithium ion secondary battery in accordance with claim 10,
wherein said polyolefin layer is bonded to a surface of said negative electrode, and said solid electrolyte layer is bonded to a surface of said polyolefin layer.

14. The lithium ion secondary battery in accordance with claim 10,
wherein said polyolefin layer is bonded to a surface of said negative electrode, and said solid electrolyte layer is bonded to a surface of said positive electrode.

15. The lithium ion secondary battery in accordance with claim 10,
wherein said solid electrolyte layer is bonded to a surface of said positive electrode, and said polyolefin layer is bonded to a surface of said solid electrolyte layer.
